(19) United States
(12) Patent Application Publication
(10) Pub. No.: US 2007/0253121 A1
(43) Pub. Date: Nov. 1, 2007

(54) SPIN ACCUMULATION DEVICE AND MAGNETIC SENSOR APPLIED WITH SPIN CURRENT CONFINED LAYER

(76) Inventors: MASAKI YAMADA, Sendai (JP); Hiromasa Takahashi, Hachioji (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/739,795

(22) Filed: Apr. 25, 2007

(30) Foreign Application Priority Data
Apr. 26, 2006 (JP) 2006-121663

(51) Int. Cl. G11B 5/33

(52) U.S. Cl. 360/324.11

(57) ABSTRACT

A spin accumulation device with high output, high resolution, and low noise. A spin current confined layer is located between a voltage-detection magnetic conductive material and a nonmagnetic conductive material. A spin current alone flows through the spin current confined layer. Due to the confinement of the spin current, since it is possible to prevent the spin current from flowing through excess portions other than the scatterer that exhibits resistance change, the detection efficiency of the spin accumulation device is dramatically increased.

### CLAIM OF PRIORITY

The present application claims priority from Japanese application JP 2006-121663 filed on Apr. 26, 2006, the content of which is hereby incorporated by reference into this application.

### BACKGROUND OF THE INVENTION

1. Field of the Invention

The present invention relates to a spin accumulation device and a method for manufacturing the same.

2. Background Art

In the market of magnetic recording and reproducing apparatus, improvement in recording density is demanded by an annual rate of more than 40%, and it is estimated that Tbit/in² will be reached by the year of 2010 or so in accordance with the current rate of growth. Higher output or higher resolution is demanded for a magnetic recording and reproducing head mounted on a terabit-level magnetic recording and reproducing apparatus. Regarding a current magnetic recording and reproducing apparatus, as an element technology, a CPP-GMR (Current Perpendicular to Plane Giant Magneto Resistance) head or a TMR (Tunneling Magneto Resistance) head in which a sense current is caused to flow perpendicular to a plane of laminated layers is proposed. Regarding the CPP-GMR head, an increase in output in the case of GMR is attempted through the effect of a specular GMR in which a Nano Oxide Layer (NOL) or the like is interposed between layers of the GMR structure for producing an increased output through the multiple reflection effect of electron spin or the effect of CCP-NOL in which Current Confined Pass (CCP) is used with a NOL formed by changing oxidation conditions. Typical examples of such CPP-GMR utilizing the CCP-NOL effect include JP Patent Publication (Kohyo) No. 2004-355682 A. Further, regarding a recently-reported TMR element having an MgO barrier layer, those having a resistance change rate greater than 300% at room temperature have began to appear.

However, it is conceivable that the above CPP-GMR or TMR head is not suitable for a terabit-level magnetic recording and reproducing apparatus from a viewpoint of resolution. This is because, while such terabit-level magnetic recording and reproducing apparatus is required to have both track pitch and gap pitch of approximately 30 nm, since the CPP-GMR or TMR head is a lamination-type magnetic head, it is conceivable that it is difficult to narrow the gap pitch thereof.

Thus, as a super-high resolution reproducing head, a planer MR read head using a spin accumulation device has been proposed. The spin accumulation effect is a phenomenon in which spin-polarized electrons (spin current) are stored in a nonmagnetic metal by causing a current to flow from a ferromagnetic material to the nonmagnetic metal in cases in which the length of the nonmagnetic metal is sufficiently shorter than a spin-diffusion length. Causing a current to flow from a ferromagnetic material to a nonmagnetic metal in this way is referred to as a “spin injection.” This is attributable to the fact that, since a ferromagnetic material generally has a different spin density at the Fermi level (the number of up-spin electrons and that of down-spin electrons are different), if a current is caused to flow from the ferromagnetic material to the nonmagnetic metal, spin current are injected, and as a result, the chemical potential of the up-spin electrons and that of the down-spin electrons are made different from each other. In a system that comprises a ferromagnetic metal/a nonmagnetic metal and that generates this spin injection, if a second ferromagnetic material is disposed in contact with the nonmagnetic metal, when spin current is stored in the nonmagnetic metal, a voltage is induced between the nonmagnetic metal and the second ferromagnetic metal. By controlling the magnetization of a first ferromagnetic material and that of the second ferromagnetic material so that they are parallel to or anti-parallel to each other, the differences of voltage can be obtained as an output signal depending on the direction of magnetization (see Non-patent Document 1). This effect can be applied as an external magnetic field sensor, and JP Patent Publication (Kokai) No. 2004-348850 A, JP Patent Publication (Kokai) No. 2004-186274 A, and JP Patent Publication (Kokai) No. 2005-19561 A report typical magnetic reproducing sensors using the spin accumulation phenomenon. While a conventional CPP-GMR or TMR head has a structure in which a free layer and a pinned layer are stacked, based on the planer spin accumulation MR read head, it is possible to realize a head structure in which the free layer and the pinned layer are separated by about several hundred nm. Thus, it is expected as a super-high resolution reproducing head.

Patent Document 1: JP Patent Publication (Kohyo) No. 2004-355682 A

Patent Document 2: JP Patent Publication (Kokai) No. 2004-348850 A

Patent Document 3: JP Patent Publication (Kokai) No. 2004-186274 A

Patent Document 4: JP Patent Publication (Kokai) No. 2005-19561 A

Non-patent Document 1: F. J. Jedema et al., “Electrical detection of spin precession in a metallic mesoscopic spin valve”, Nature, vol. 416 (2002), pp. 713-716.

### SUMMARY OF THE INVENTION

Currently, a reported output signal due to the spin accumulation effect is 8 mΩ when a tunneling junction is used (Non-patent Document 1). However, such output amplitude is insufficient for a terabit-level magnetic recording and reproducing head, and therefore a spin accumulation device having an even higher output is needed. Further, based on the spin accumulation device using the tunneling junction, since the influence of noise is not negligible, simply adding a tunneling junction for achieving an increased output does not provide a function as an external magnetic field sensor. Thus, as a terabit magnetic reproducing sensor, an external magnetic field sensor having a spin accumulation device with high sensitivity, high resolution, and low noise is needed.

In the present invention, a spin current accumulated in a nonmagnetic conductive material is confined, so as to achieve a higher output. In order to confine the spin current, a spin current confined layer including an insulating material or the like in which nano-scale size nonmagnetic conductive materials are embedded is provided. While a current confined layer in the case of the CPP-GMR has a film thickness of about 1 to 2 nm, an arbitrary film thickness of the spin current confined layer of the present invention can be selected in the range of several nm to several hundred nm; in principle, it is possible to select a film thickness in the range shorter than the length of spin diffusion. Further, unlike the CCP-NOL that is generally manufactured by oxidizing a magnetic ultrathin film, the spin current confined layer is manufactured by subjecting a nonmagnetic thin film to partial oxidation. The spin current confined layer according to the present invention is different from the current confined layer in the case of the CPP-GMR in that only a nonmagnetic conductive material can be used for the spin current confined portion. This is because, if a magnetic conductive material is used, since the spin diffusion length is merely on the order of several nm, spin information cannot be sent in a film thickness direction.

Based on the current confined layer in the case of the CPP-GMR, since an electrical current is confined and caused to flow, electrical current density is high in a pinhole portion. Thus, it is problematic in that the pinhole portion is deteriorated due to Joule's heat or the like. However, based on the spin current confined layer according to the present invention, since no electrical current flows, such problem does not occur. Further, instead of an electrical current, since the spin current flows through the spin current confined layer, the present invention is characterized in that electrical noise can be reduced when measuring a voltage. Thus, it is possible to realize a magnetic reproducing sensor with high sensitivity, high resolution, and low noise that can accommodate a terabit magnetic recording and reproducing apparatus.

In accordance with the present invention, a spin accumulation device suitable for conducting high-recording-density magnetic recording and reproducing can be obtained with high output, high resolution, and low noise.

### BRIEF DESCRIPTION OF THE DRAWINGS

FIG. 1 shows a cross-sectional view of a structural example of a spin accumulation device according to the present invention.

FIG. 2 shows a plan view of the structural example of the spin accumulation device according to the present invention.

FIG. 3 shows the cross-sectional area dependence of an output signal of the spin accumulation device according to the present invention.

FIG. 4 shows a cross-sectional area of a structural example of a spin accumulation device according to the present invention.

FIG. 5 shows a plan view of the structural example of the spin accumulation device according to the present invention.

FIG. 6 shows a structural example of a spin current confined layer of the present invention.

FIG. 7 shows a cross-sectional view of a structural example of a spin accumulation device according to the present invention.

FIG. 8 shows a cross-sectional view of a structural example of a spin accumulation device according to the present invention.

FIG. 9 shows a schematic diagram of a magnetic recording and reproducing apparatus according to the present invention.

FIG. 10 shows a schematic diagram of a magnetic reproducing sensor having a spin accumulation device provided with a spin current confined layer.

### DESCRIPTION OF PREFERRED EMBODIMENTS OF THE INVENTION

A device shape and an external magnetic field sensor to which the present invention is preferably applied will be described hereafter in detail.

### Example 1

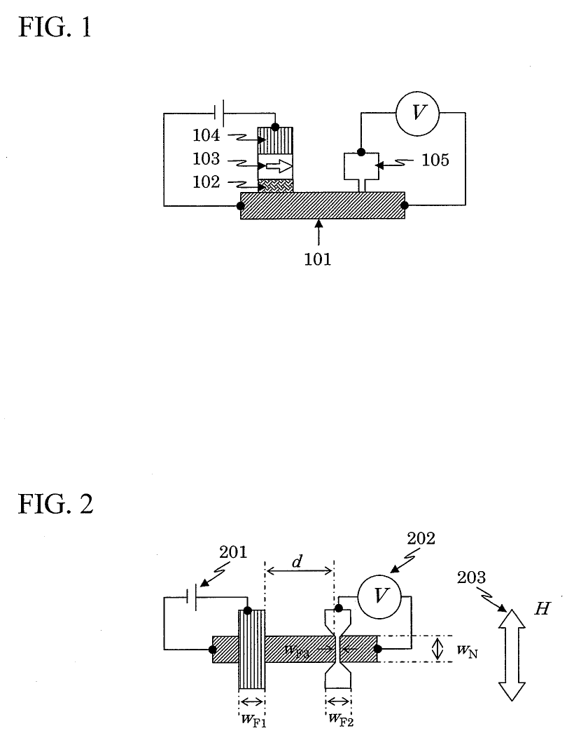

FIG. 1 shows a sectional side view of a spin accumulation device according to a first example of the present invention, and FIG. 2 shows a plan view of the device. The spin accumulation device is structured so that a nonmagnetic conductive material 101 and a first magnetic conductive material 103 are in contact with an insulating barrier layer 102 formed on the nonmagnetic conductive material 101 and so that a second magnetic conductive material 105 is in contact with the nonmagnetic conductive material 101 at another location. Magnetization of the first magnetic conductive material 103, which functions as a spin injection source, is magnetically fixed by an anti-ferromagnetic material 104. A voltage induced by the spin accumulation effect in the nonmagnetic conductive material 101 is detected between the second magnetic conductive material 105 and the above nonmagnetic conductive material 101. The voltage-detection second magnetic conductive material 105 was formed so that it had a narrow part, and it was finely fabricated so that the junction area A₂(=w_{F3}×w_{N}) with the nonmagnetic conductive material 101 had a size of 0.01 μm² or less. The nonmagnetic conductive material 101 is comprised of a nonmagnetic conductive metal selected from Cu, Au, Ag, Pt, Al, Pd, Ru, Ir, Rh, or the like. Alternatively, it may be comprised of a conductive compound containing GaAs, Si, TiN, TiO, or ReO₃ as a major ingredient.

The first and second magnetic conductive materials 103 and 105 are comprised of Co, Ni, Fe, or Mn, or of an alloy or a compound containing at least one kind of these elements as a major ingredient. Alternatively, these magnetic layers may contain: oxides having the structure AB₂O₄ (A represents at least one of Fe, Co, and Zn, and B represents one of Fe, Co, Ni, Mn, and Zn) typified by half-metal Fe₃O₄; compounds in which at least one element of the transition metals Fe, Co, Ni, Cr, and Mn is added to CrO₂, CrAs, CrSb, or ZnO; compounds in which Mn is added to GaN; or Heusler alloys of a C₂D×E×F type typified by CO₂MnGe, CO₂MnSb, CO₂Cr_{0.6}Fe_{0.4}Al, and the like (material in which C represents at least one kind of Co, Cu, and Ni; D and E each represent one kind of Mn, Fe, and Cr; and F represents at least one component of Al, Sb, Ge, Si, Ga, and Sn). As the anti-ferromagnetic material 104, MnIr, MnPt, MnRh, or the like may be used, and as the insulating barrier layer, a single film or laminated film comprised of material containing at least one kind of MgO, Al₂O₃, AlN, SiO₂, HfO₂, Zr2O₃, Cr₂O₃, TiO₂, and SrTiO₃ may be used.

In FIG. 2, reference characters w_{N}, w_{F1}, w_{F2}, w_{F3}, and d denote the wire width of the nonmagnetic conductive material 101, the wire width of the first magnetic conductive material 103, the wire width of the second magnetic conductive material 105, the width of a confined part of the second magnetic conductive material 105, and the distance between the electrodes of the first and second magnetic conductive materials, respectively. The junction area of the nonmagnetic conductive material 101 and the first magnetic conductive material 103 is defined by A₁=w_{N}×w_{F1}, and the junction area of the nonmagnetic conductive material 101 and the second magnetic conductive material 105 is defined by A₂=w_{N}×w_{F3}. Reference numeral 201 denotes a DC current source, and 202 denotes a voltmeter. An external magnetic field 203 is applied in a direction parallel to the first and second magnetic conductive materials 103 and 105.

The spin accumulation device of the present example was made as described below. A film was formed on a commonly-employed substrate such as a SiO₂ substrate or a glass substrate (including a magnesium oxide substrate, a GaAs substrate, an AlTiC substrate, a SiC substrate, and an Al₂O₃ substrate) by RF sputtering, DC sputtering, molecular beam epitaxy (MBE), or the like, using a film formation apparatus. For example, in the case of RF sputtering, in the presence of Ar, a predetermined film was allowed to grow with a pressure of about 0.1 to 0.001 Pa and a power of 100 W to 500 W. As the subtracted on which the device is formed, the above substrate was directly used or such substrate having an insulating film, a suitable underlaying metal film, or the like formed thereon was used.

As an example of film formation, films Ta (3 nm)/Cu (30 nm) were deposited as an electrode for measuring magnetoresistance on a Si substrate having a three-inch thermally-oxidized film, using an RF magnetron sputtering apparatus. After the film deposition, the pattern was exposured using an i-line stepper, an electrode for measuring magnetoresistance was fabricated by ion milling, and a burr removal process was carried out. After the electrode was made, individual films; that is, MnIr (10 nm)/CoFeB (20 nm)/MgO (2.2 nm)/Cu (20 nm) from bottom to top, were deposited.

For processing the device, nano-fabrication was carried out with an electron beam lithography method, a scanning probe lithography method, or the like. For example, a narrow Cu wire (50 nm—width, 50 μm—length, and 20 nm—thickness) was fabricated using a scanning probe lithography method. The device sizes indicate the nonmagnetic wire width w_{N}: 50 to 500 nm, the magnetic wires width w_{F1}, w_{F2}: 100 to 500 nm, and the distance d between the magnetic electrodes was 50 to 600 nm, respectively. A selective dry etching was applied to the junction of the magnetic wires and the nonmagnetic wire, so as to make a tunneling junction for a spin injection terminal.

While Cu was used for the nonmagnetic conductive material, the Cu wire was annealed at 240° C. for 50 minutes in vacuum. Through this annealing process, the particle size of Cu was made larger, and even when the Cu wire had a wire width of 100 nm, it exhibited a resistance value of 1.8 μΩcm.

The voltage-measurement second magnetic conductive material 105 was finely processed so that the junction had a narrow shape, by using a scanning probe lithography method. The resistance of the junction made exhibited a metal-like behavior, and five sizes of the junction; that is, A₂=0.1 μm², 0.025 μm², 0.01 μm², 0.0075 μm², and 0.0050 μm², were prepared.

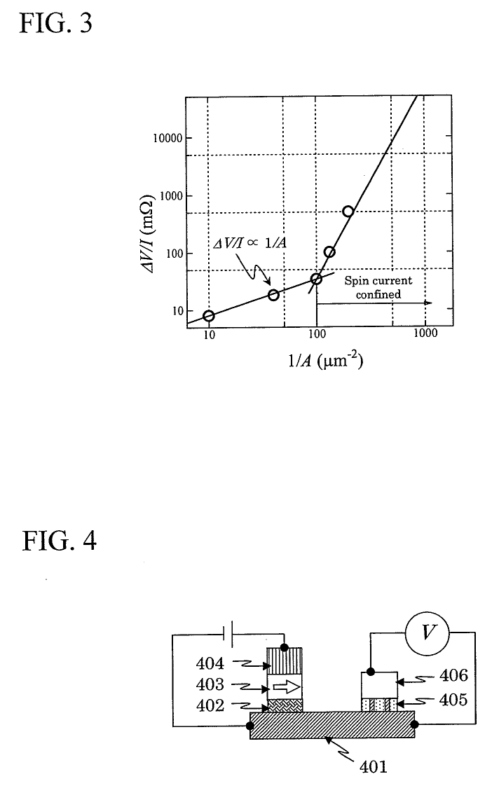

Based on the first tunneling junction of the spin accumulation device of the present invention, a constant DC current I=0.1 mA was caused to flow from CoFeB to Cu via the MgO film, and a voltage between CoFeB of the second magnetic conductive material and the Cu film was measured (see FIG. 2). The external magnetic field 203 was applied parallel to the magnetic wires, and the magnetization of the second magnetic material 105 was reversed. Voltages were measured in a state in which the magnetization of the two magnetic layers was parallel to and anti-parallel to each other, and an output signal ΔV/I was obtained based on the difference between the obtained voltages. The distance between the electrodes of the first and the second magnetic materials was d=300 nm. FIG. 3 shows the relationship between the output signal ΔV/I and the reciprocal of a cross-sectional area 1/A₂.

As shown in FIG. 3, the results shows that the output signal is sharply increased when A₂<0.001 μm². When the cross-sectional area A₂ of the voltage-detection terminal is sufficiently larger than the crystal grain size of the nonmagnetic wire (A₂>>0.01 μm²), the output signal is proportional to the reciprocal of the cross-sectional area. In contrast, as the cross-sectional area is decreased to be 0.01 μm² or less, the relationship that the output signal is proportional to the reciprocal of the cross-sectional area is deviated, and as a result, it is sharply increased. This phenomenon can be interpreted as the effects of reducing the scattering of spin current in a crystal grain boundary and of increasing spin-current absorption efficiency, since it is possible to prevent the spin current from flowing through excess portions other than the scatterer that exhibits resistance change when the cross-sectional area is approximately equal to or less than the crystal grain size of the nonmagnetic metal. Thus, by decreasing the junction area of the nonmagnetic conductive material 101 and the voltage-detection magnetic conductive material 105, the spin current is confined, and as a result, the output due to the spin accumulation effect is sharply increased.

In the present invention, the effect of spin current confinement is actively used, so as to amplify the output signal through the spin accumulation effect.

### Example 2

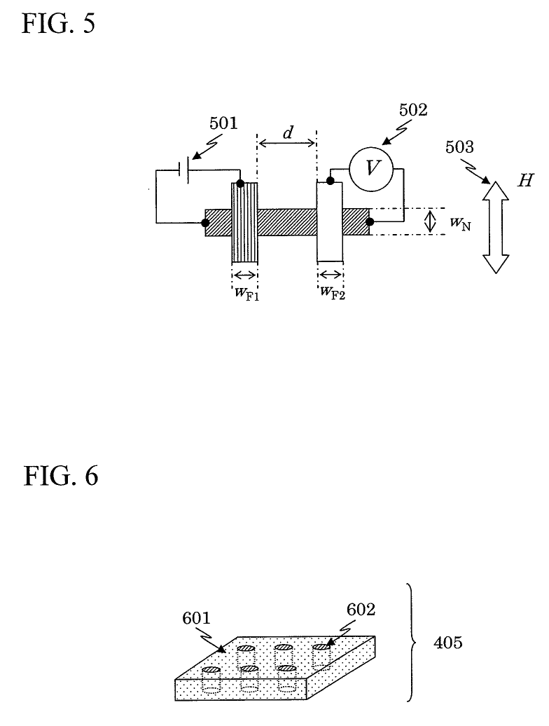

FIG. 4 shows a sectional side view of a spin accumulation device according to a second example of the present invention, and FIG. 5 shows a plan view of the device. This spin accumulation device is provided with a spin current confined layer 405 between a voltage-detection magnetic conductive material 406 and a nonmagnetic conductive material 401 (see FIG. 6). The nonmagnetic conductive material 401, an insulating barrier layer 402, a magnetic conductive material 403, and an anti-ferromagnetic material 404 used in the present example were the same as those used in Example 1.

As shown in FIG. 5, the junction area of the spin current confined layer 405 and the nonmagnetic conductive material 401 is defined by A₂′=w_{N}×w_{F2}. Note that the junction area A₂′ was obtained by measuring the wire width w_{N} of the nonmagnetic wire and the wire width w_{F2} of the magnetic wire with an atomic force microscopy. Reference numerals 501 and 502 denote a DC current source and a voltage detector, respectively, and an external magnetic field 503 was applied parallel to the two magnetic conductive materials 403 and 406. The output from the spin accumulation device provided with the spin current confined layer 405 exhibits two orders of magnitude greater than conventionally-reported output signals. This can be interpreted as follows: since it is possible to prevent the spin current flowing through excess portions other than the scatterer that causes resistance change by confining the spin current, the output signal of the spin accumulation device is increased as a result.

FIG. 6 schematically shows an enlarged view of the spin current confined layer 405 comprising an insulating material 601 in which nonmagnetic conductive materials 602 each having a diameter of 10 nm or less are disposed. The insulating material 601 was formed by subjecting a nonmagnetic conductive material film to partial oxidation, and a spin current confined layer having nanoholes was made. Examples of the material for the nonmagnetic conductive materials 602 include Cu, Au, Ag, Pt, Al, Pd, Ru, Ir, and Rh, and the spin current was confined by making the film thickness thereof 100 nm or less. For example, by using a nonmagnetic conductive material Au having a large spin orbit interaction, the spin-sink effect can be expected, and therefore, the spin current can be detected more efficiently.

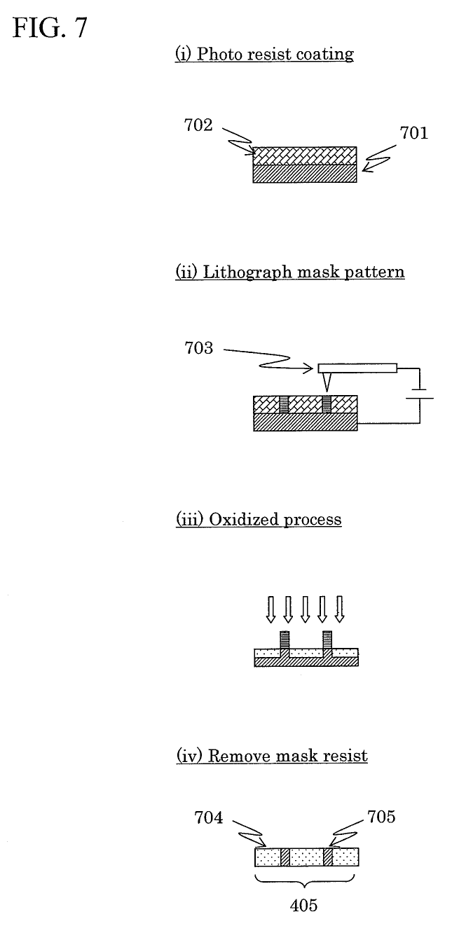

FIG. 7 shows an example of a method for making the spin current confined layer through partial oxidation.

(i) A nonmagnetic conductive material thin film 701 is formed on the nonmagnetic conductive material thin film 401, and a negative photoresist 702 is then applied thereon.
(ii) With a scanning probe 703, a mask pattern is drawn on the photo resist 702.
(iii) Oxidation is carried out during Ar plasma irradiation in the presence of oxygen, so as to make an oxide insulating material 704.
(iv) In accordance with the above process, the spin current confined layer 405 comprising the oxide insulating material 704 in the body of which the columnar nonmagnetic conductive materials 705 are distributed is completed.

Alternatively, the spin current confined layer can be made by using porous ceramics as a mask.

In accordance with the method described below, the spin accumulation device of the present example was made. The manufacturing method of the present example was carried out in the same manner as in Example 1, except that the spin current confined layer 405 shown in FIG. 6 was provided, instead of the narrow shape of the second magnetic layer 105 in Example 1. Regarding the spin current confined layer 405, Cu was used for the nonmagnetic thin film, and the oxide insulating material 601 having a film thickness of 3 nm or less was formed through the partial oxidation shown in FIG. 7. The spin current confined layer 405 was processed so that the diameter of each of the Cu columnar conductive materials 602 in the insulating material 601 was 1 to 3 nm and so that the distance between the individual Cu columnar conductive materials 602 was 5 nm.

The output signal of the spin accumulation device comprising the spin current confined layer made as described above was measured. Measurement conditions were as follows: a constant direct current I=0.1 mA was caused to flow from CoFeB to Cu via the MgO film; and a voltage between CoFeB and Cu wires connected via the spin current confined layer was measured. As the junction area was decreased to be A₂′<0.001 μm, the output signal was sharply increased. When the junction area of the spin current confined layer was A₂′=0.0001 μm², the value ΔV/I=5Ω was obtained as the output signal.

### Example 3

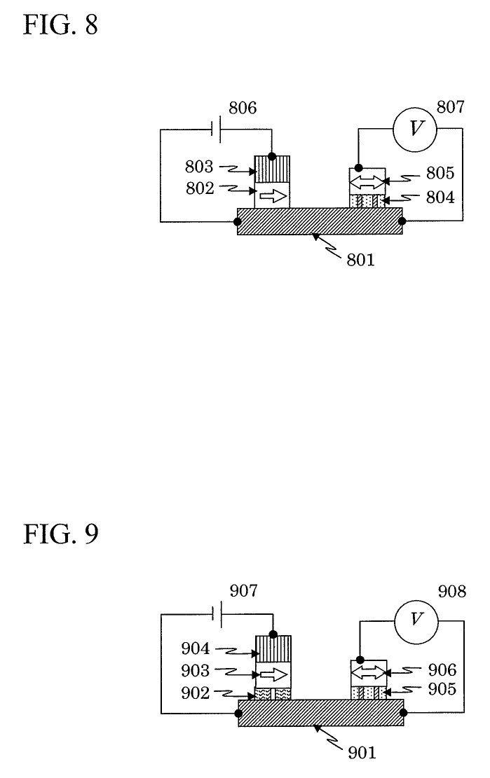

FIG. 8 shows a sectional side view of a spin accumulation device according to a third example of the present invention. Based on the present spin accumulation device, a magnetic conductive material 802 that injects a current 806 and a nonmagnetic conductive material 801 are electrically in direct contact with each other. The nonmagnetic conductive material 801, magnetic conductive materials 802 and 805, and an anti-ferromagnetic material 803 used in the present example were the same as those used in Example 1, and a spin current confined layer 804 used in the present example was the same as that used in Example 2. Since the nonmagnetic conductive material 801 and the magnetic conductive material 802 are electrically in direct contact with each other, a low-noise spin accumulation device can be obtained. Additionally, since the spin current confined layer 804 is used, higher output can be achieved as in Example 2.

### Example 4

FIG. 9 shows a sectional side view of a spin accumulation device according to a fourth example of the present invention. Based on the present spin accumulation device, a magnetic conductive material 903 that injects a current 907 and a nonmagnetic conductive material 901 are electrically connected via a current confined layer 902. The nonmagnetic conductive material 901, magnetic conductive materials 903 and 906, an anti-ferromagnetic layer 904 used in the present example were the same as those used in Example 1, and a spin current confined layer 905 used in the present example was the same as that used in Example 2. Further, the current confined layer 902 made by subjecting a magnetic thin film to partial oxidation was used. Ni, Co, Mg, Fe, or the like was used for the current-confinement magnetic conductive materials, and the current confined layer 902 was made through Ar plasma irradiation in the presence of oxygen. In accordance with the present example, since the nonmagnetic conductive material 901 and the magnetic conductive material 903 are connected via the current confined layer 902, a device having resistance lower than that of the spin accumulation device in Example 2 that uses tunneling junction can be obtained.

Thus, based on the spin accumulation device of Example 2, 3, or 4 provided with the spin current confined layer, since the value of the output signal is two or more orders of magnitude greater than those reported so far (non-Patent Document 1), the device can obtain sufficient output as a magnetic reproducing sensor even in reproduction regions where reproduction density exceeds Tbit/in². Further, since only the spin current flows through the spin current confined layer, electrical noise was reduced when measuring a voltage, and thermal tolerance with respect to Joule heat caused by the spin current confinement was improved, as compared with a current confined layer in the case of the CPP-GMR.

### Example 5

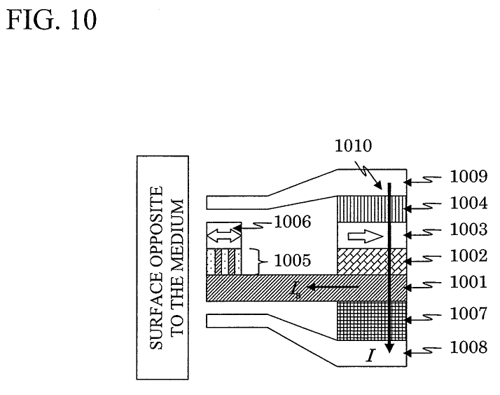

FIG. 10 shows a schematic diagram of a magnetic reproducing sensor comprising a spin accumulation device provided with a spin current confined layer. The spin accumulation device provided with a spin current confined layer 1005 is located between the top and the bottom shields 1008 and 1009, and a magnetic conductive material 1006, which is a free layer, is located opposite to a medium as an external magnetic sensor on the ABS surface. An insulating barrier layer 1002, a magnetic conductive material 1003, which is a pinned layer, and an anti-ferromagnetic conductive material 1004 are stacked and formed on a nonmagnetic conductive material 1001 at a distance from the surface opposite to the medium. Reference numeral 1007 denotes an electrode. A current 1010 is caused to flow between the top and the bottom shields 1008 and 1009 in a direction in which the individual layers are stacked, and an electric potential difference between the magnetic conductive material 1006 and the nonmagnetic conductive material 1001 is detected. By increasing the junction area (A₁=0.1 m²) of the insulating barrier layer 1002, the total amount of the injected spin current was increased, and breakdown of the junction due to Joule heat generated when the current 1010 flows through the tunneling junction was prevented.

The junction area Aₗ of the nonmagnetic conductive material 1001—the anti-ferromagnetic conductive material 1004 and the electrode 1007 is A₁=0.1 μm², and the cross-sectional area A₂′ of the spin current confined layer 1005 is A₂′=0.001 μm². Based on the magnetic reproducing sensor comprising the present spin accumulation device, when the distance between the free layer 1006 and the pinned layer 1003 is d=300 nm, the output signal exceeds ΔV/I=1Ω.

What is claimed is:

1. A spin accumulation device, comprising:
a nonmagnetic conductive material;
a first magnetic conductive material formed on the nonmagnetic conductive material via an insulating barrier layer;
an electrode for allowing the flow of an electric current between the nonmagnetic conductive material and the first magnetic conductive material via the insulating barrier layer;
a second magnetic conductive material formed on the nonmagnetic conductive material at a distance from the insulating barrier layer; and
an electrode for allowing the measurement of a voltage generated between the nonmagnetic conductive material and the second magnetic conductive material,
wherein the junction area of the second magnetic conductive material and the nonmagnetic conductive material is 0.001 μm² or less.

2. The spin accumulation device according to claim 1, wherein an anti-ferromagnetic conductive material is formed on the first magnetic conductive material.

3. The spin accumulation device according to claim 1, wherein no current flows between the nonmagnetic conductive material and the second magnetic conductive material.

4. A spin accumulation device, comprising:
a nonmagnetic conductive material;
a first magnetic conductive material formed on the nonmagnetic conductive material;
an electrode for allowing the flow of an electric current between the nonmagnetic conductive material and the first magnetic conductive material;
a second magnetic conductive material formed on the nonmagnetic conductive material via a spin current confined layer at a distance from the first magnetic conductive material; and
an electrode for allowing the measurement of a voltage generated between the nonmagnetic conductive material and the second magnetic conductive material.

5. The spin accumulation device according to claim 4, wherein the spin current confined layer comprises an insulating material in the body of which columnar nonmagnetic conductive materials are distributed.

6. The spin accumulation device according to claim 4, wherein an anti-ferromagnetic material is formed on the first magnetic conductive material.

7. The spin accumulation device according to claim 4, wherein an insulating barrier layer is formed between the nonmagnetic conductive material and the first magnetic conductive material.

8. The spin accumulation device according to claim 4, wherein a current confined layer is formed between the nonmagnetic conductive material and the first magnetic conductive material.

9. The spin accumulation device according to claim 5, wherein the nonmagnetic conductive material comprises Cu, Au, Ag, Pt, Al, Pd, Ru, Ir, or Rh, and the insulating material comprises an oxide of the nonmagnetic conductive material.

10. The spin accumulation device according to claim 5, wherein the spin current confined layer has a film thickness of 100 nm or less, and the columnar nonmagnetic conductive materials each have an in-plane cross-sectional area of 0.001 μm² or less.

11. The spin accumulation device according to claim 4, wherein no current flows through the spin current confined layer, and a spin current interacts with the second magnetic conductive material only via the nonmagnetic conductive material of the spin current confined layer.

12. A method for manufacturing a spin accumulation device, the device comprising: a spin injection unit for injecting spin current into a nonmagnetic conductive material; and a detection unit that is disposed at a distance from the spin injection unit and that detects an interaction between spin current accumulated in the nonmagnetic conductive material and a magnetic conductive material,
wherein the detection unit is manufactured by steps including:
applying a photo resist to a nonmagnetic conductive material thin film formed on a nonmagnetic electrode;
drawing a mask pattern on the photo resist with a scanning probe lithography method;
subjecting the nonmagnetic conductive material thin film to partial oxidation during Ar plasma irradiation in the presence of oxygen, so as to form a spin current confined layer comprising an oxide insulating material in the body of which columnar nonmagnetic conductive materials are distributed; and
forming a ferromagnetic layer that is to be a free layer on the spin current confined layer.
